(19) United States
(12) Patent Application Publication
(10) Pub. No.: US 2010/0328205 A1
(43) Pub. Date: Dec. 30, 2010

(54) MAGIC FINGER MOUSE

(76) Inventor: Wen-Lung Cheng, Taipei Hsien (TW)

Correspondence Address: Wen-Lung Cheng, 235 Chung - Ho Box 8-24, Taipei, 235, TW

(21) Appl. No.: 12/494,261

(22) Filed: Jun. 29, 2009

(51) Int. Cl. G09G 5/08

(52) U.S. Cl. 345/157

(57) ABSTRACT

A magic finger mouse comprises a glove capable of being worn on a hand; the glove including a transmitter module, a sensor, a touch button and a central processing module; the central processing module having a memory and a charge cell; power of the transmitter module being from the central processing module; one end of the central processing module being installed with a USB joint; the USB joint can be inserted into a cable for further connecting to a computer so that files can be stored to the memory and charge cell can be charged through the USB joint; the transmitter module connected to the sensor for transmitting signals to a receiving module; and the receiving module installed at one end of a screen for providing signals to the transmitter module.

### FIELD OF THE INVENTION

The present invention relates to computer mice, in particular to a magic finger mouse, wherein the user's hand wears a glove of the present invention and the glove is installed with a sensor and a transmitter module. The sensor will sense the movement of the glove and the moving signals from the sensor are transferred through the transmitter module to a receiving module at one end of the screen so that the pointer on the screen will move with the movement of the glove.

### BACKGROUND OF THE INVENTION

With the development of computer science, the computer peripherals are also progressed promptly. For example, originally roller type computer mice are improved into optical mice. Furthermore, the mice are improved from wired connection to wireless connection.

To match the requirement of personality, the structure of the mouse must be improved. Thus a magic finger mouse is provided, which is a glove and can be worn upon the hand of the user. The glove is installed with a sensor and a transmitter module. With the movement of the hand, the pointer of the mouse is controlled.

### SUMMARY OF THE INVENTION

The object of the present invention is to provide a magic finger mouse comprising a glove capable of being worn on a hand; the glove including a transmitter module, a sensor, a touch button and a central processing module; the central processing module having a memory and a charge cell; power of the transmitter module being from the central processing module; one end of the central processing module being installed with a USB joint; the USB joint can be inserted into a cable for further connecting to a computer so that files can be stored to the memory and charge cell can be charged through the USB joint; the transmitter module connected to the sensor for transmitting signals to a receiving module; and the receiving module installed at one end of a screen for providing signals to the transmitter module. The user's hand wears a glove of the present invention and the glove is installed with a sensor and a transmitter module. The sensor will sense the movement of the glove and the moving signals from the sensor are transferred through the transmitter module to a receiving module at one end of the screen so that the pointer on the screen will move with the movement of the glove.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a schematic view showing that a glove is worn on the hand.

FIG. 3 is a schematic view showing another side of the glove.

FIG. 4 shows the embodiment of the present invention.

FIG. 5 is a schematic view showing the use of the touch button according to the present invention.

FIG. 6 is a schematic view showing another use of the present invention.

FIG. 7 is a schematic view showing the operation of the storage of a file according to the present invention.

FIG. 8 is an enlarge view of the central processing module of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

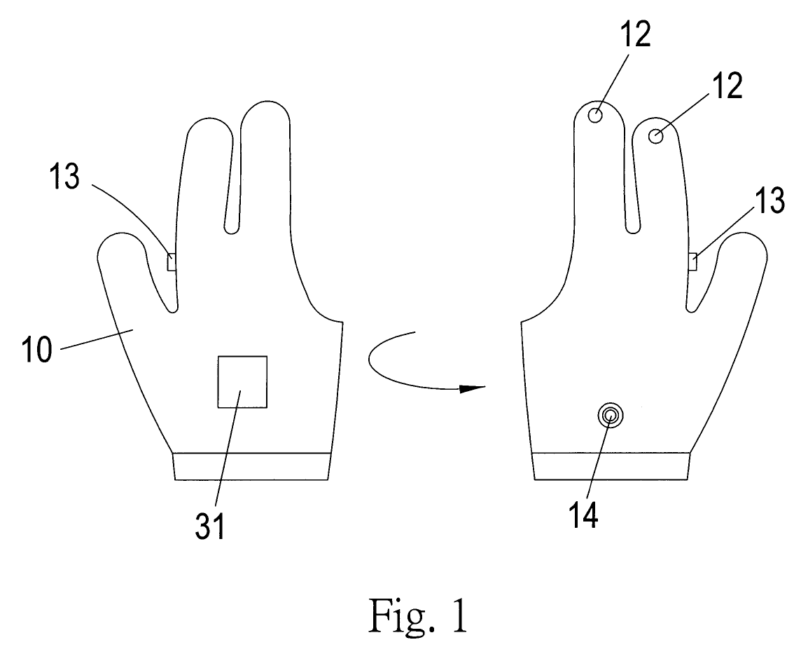

With reference to FIG. 1, the magic finger mouse comprises the following elements.

A glove 10 can be worn upon the palm 30 of the user. The glove 10 is installed with a transmitter module 11, a sensor 12, a touch button 13 and a central processing module 31.

The central processing module 31 includes a memory and a battery cell. The central processing module 31 provides power to the transmitter module 11. One end of the central processing module 31 is installed with a USB joint 33 which can be connected to a cable to be further connected to a computer so that a memory can store files and the battery cell can be charged through the USB joint 33.

The transmitter module 11 is connected to the sensor 12. The sensor 12 detects the movement of the glove. The transmitter module 11 transmits signals to the receiving module 20.

A receiving module 20 is installed at one end of a screen 21 for receiving the signals from the transmitter module 11.

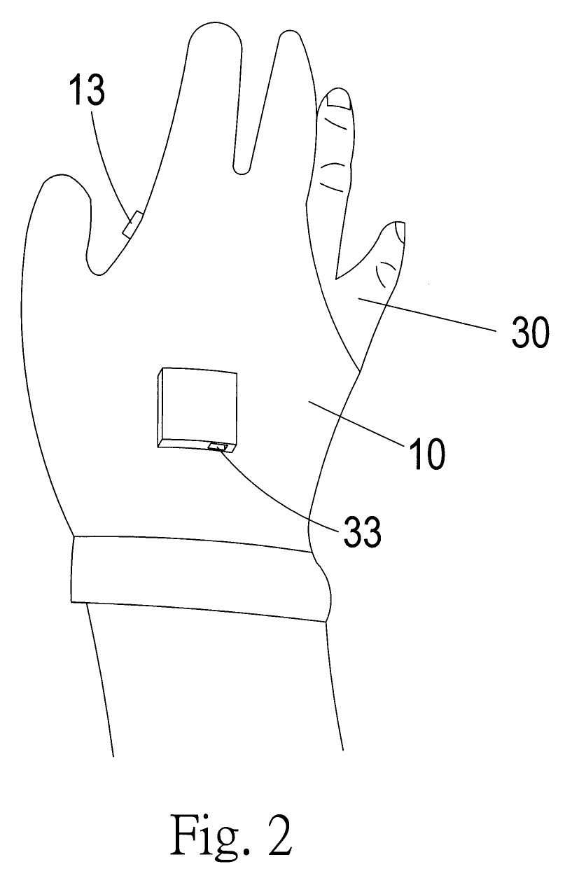

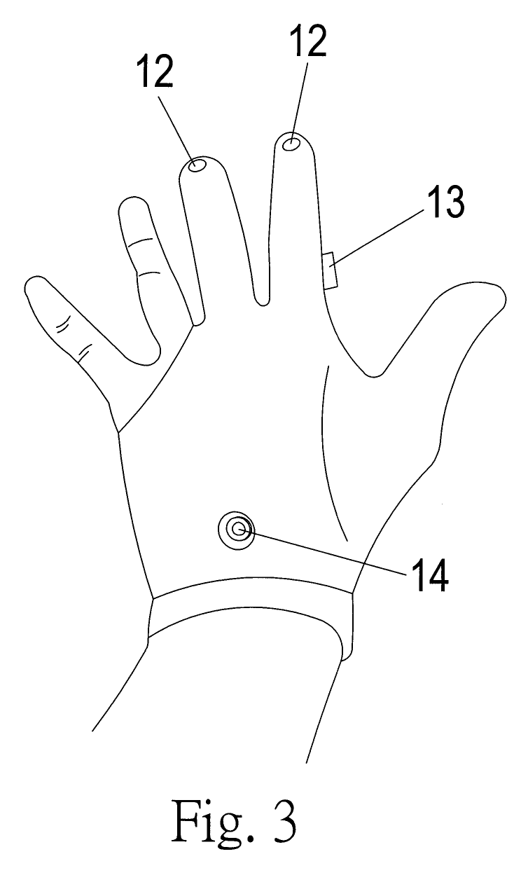

With reference to FIGS. 2 and 3, it is illustrated that the glove 10 is worn on the hand of the user. The transmitter module 11 on the glove 10 serves to transmit the signals to the receiving module 20.

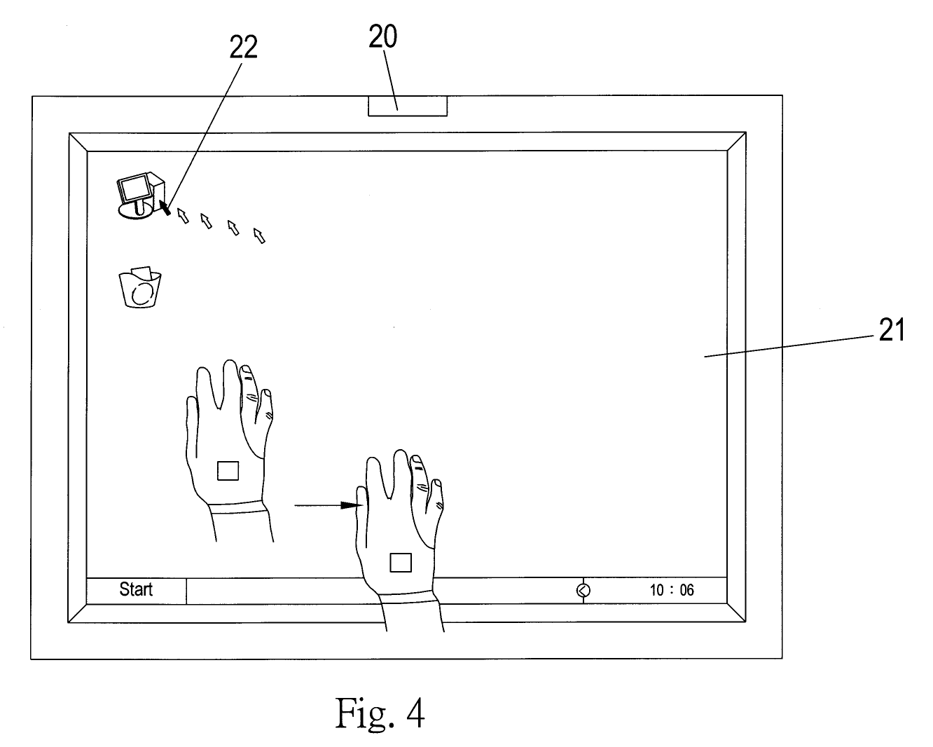

With reference to FIG. 4, the embodiment of the present invention is illustrated. The touch button 13 of the glove 10 is connected to the transmitter module 11. When the touch button 13 is touched, the signals of the sensor 12 are transferred to the receiving module 20 through the transmitter module 11. The movement of the glove 10 will be sensed by the sensor 12 so as to control the pointer on the screen 21. In use, the glove 10 is placed upon the screen 21. The transmitter module 11 of the glove 10 can transmit signals to the receiving module 20 at one end of the screen 21. In operation, the touch button 13 is pressed so that the receiving module 20 can receive signals from the sensor 12 so as to trace the movement of the glove 10. Thus the pointer 22 on the screen 21 can be controlled by the user.

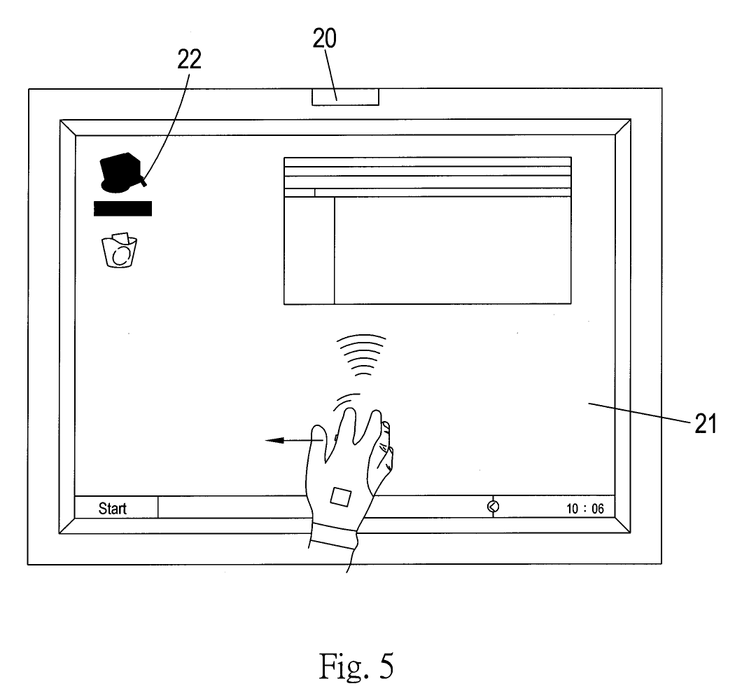

Referring to FIG. 5, the use of the present invention is illustrated, in that when the user's finger is released from the touch button 13, the pointer 22 of the screen 21 will not move with the palm 30. Then the displacement of the sensor 12 will generate the click action to actuate the icon on the window of the screen.

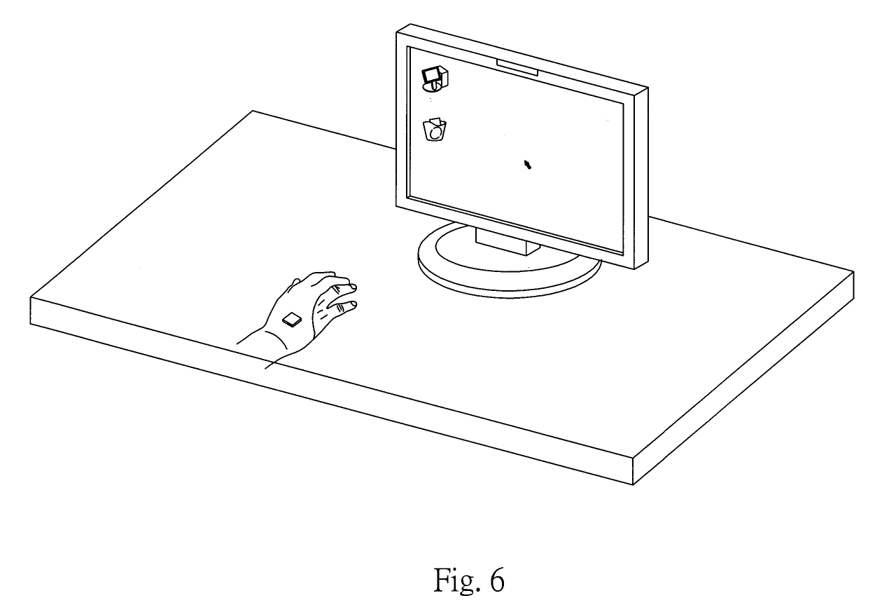

With reference to FIG. 6, another use of the present invention is illustrated, in that the sensor 12 is installed with a mouse sensor 14. when the user's hand is placed upon a table, the glove 10 may be used as a conventional mouse.

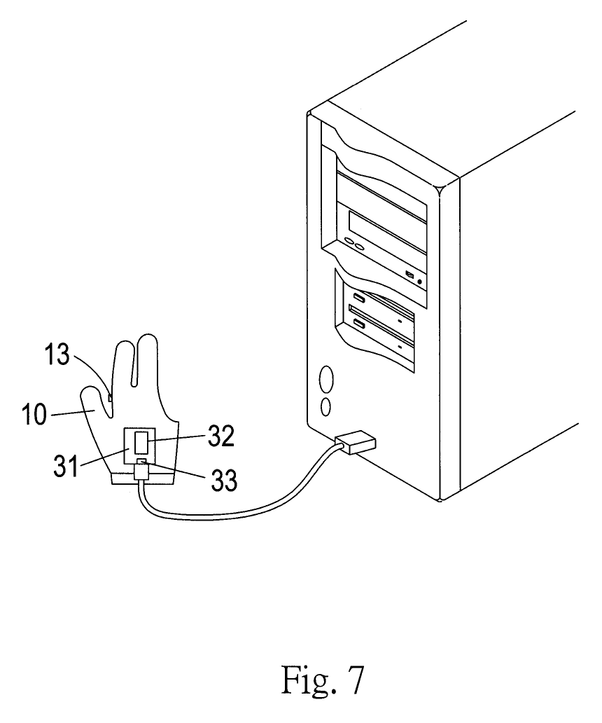

Referring to FIG. 7, the file storage of the present invention is illustrated. In that, the glove 10 is installed with the central processing module 31. The central processing module 31 includes a memory 32. One end of the central processing module 31 is installed with the USB joint 33. The USB joint 33 can be inserted into a cable for further connecting to a computer so that files can be stored to the memory 32. Meanwhile, the USB joint 33 can charge power to the central processing module 31.

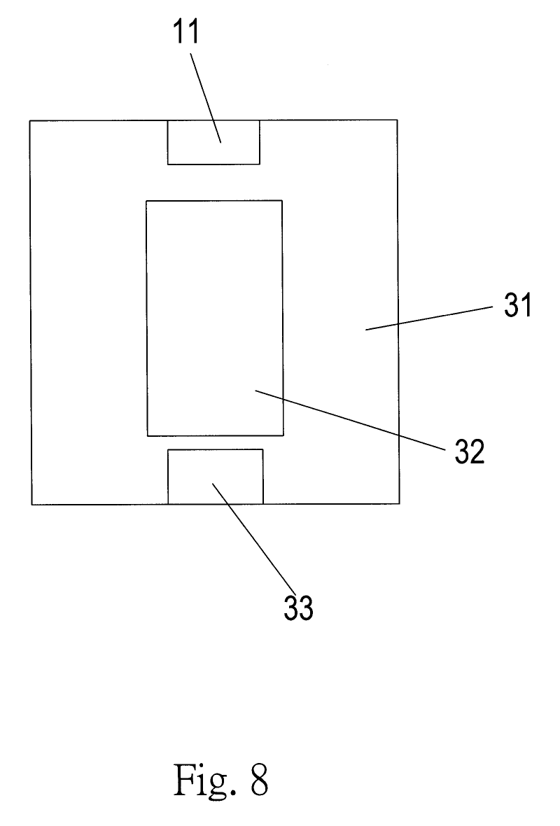

Referring to FIG. 8, an enlarged view of the central processing module 31 of the present invention is illustrated. The central processing module 31 includes a transmitter module 11, a memory 32 and a USB joint 33.

Furthermore, it should be noted that in the present invention, the transmitter module and receiving module transfer signals by infrared or blue tooth.

Advantages of the present invention will be described herein. The present invention is a novel and new trend design. The present invention has a simple structure and can be operated easily and is a personality design.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A magic finger mouse comprising;
a glove capable of being worn on a hand; the glove including a transmitter module, a sensor, a touch button and a central processing module;
the central processing module having a memory and a charge cell; power of the transmitter module being from the central processing module; one end of the central processing module being installed with a USB joint; the USB joint can be inserted into a cable for further connecting to a computer so that files can be stored to the memory and charge cell can be charged through the USB joint;
the transmitter module connected to the sensor for transmitting signals to a receiving module; and
the receiving module installed at one end of a screen for providing signals to the transmitter module.

2. The magic finger mouse as claimed in claim 1, wherein the transmitter module and receiving module transfer signals by infrared or blue tooth.

3. The magic finger mouse as claimed in claim 1, wherein the touch button is connected to the transmitter module, when the touch button is pressed, the sensor will transfer signals to the receiving module through the transmitter module; with the movement of the sensor, the movement of the glove will drive the pointer on the screen.

4. The magic finger mouse as claimed in claim 1, wherein the sensor is installed with a mouse sensor so that the glove can act as a conventional mouse, that is when the glove is placed upon a table, the movement of the glove will drive the pointer on the screen.
